(19) United States
(12) Patent Application Publication
(10) Pub. No.: US 2005/0151860 A1
(43) Pub. Date: Jul. 14, 2005

(54) Image sensing device and method

(76) Inventors: D. Amnon Silverstein, Mountain View, CA (US); Suk Hwan Lim, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/753,507

(22) Filed: Jan. 8, 2004

(51) Int. Cl. H04N 5/335

(52) U.S. Cl. 348/272

(57) ABSTRACT

An image sensing device and a method of capturing an electronic representation of an image includes a plurality of photosensors arranged in one or more arrays, and a filter associated with each of the photosensors. The photosensors and their respective output signals are divided into a plurality of color channels. At least one of the color channels is divided into a plurality of sub-channels. Each of the sub-channels registers light in spectral bands which approximate the color of the respective color channel. However, the first sub-channel registers light in a spectral band which is broader in bandwidth than the second sub-channel.

### TECHNICAL FIELD

This invention relates to an image sensing device for digital image capture apparatus such as digital still cameras and analog and digital video cameras, scanners such as film or flat bed scanners, and other imaging systems and devices.

### BACKGROUND OF THE INVENTION

Unlike traditional cameras that use film to capture and store an image, digital cameras and other digital image capture devices as well as analog video cameras use a solid-state device, which is referred to herein as an image-sensing device to create an electronic representation of the image being captured. One type of image-sensing device which is in common usage is a mosaic type device in which an imaging photosensor array such as a Charge Coupled Device (CCD), a Charge Injection device (CID) or a CMOS detector array is tiled with color filters in a Bayer pattern, in stripes or in some other regular arrangement. One example of such a prior art device is a Sony ICX205AK Progressive Scan CCD Image Sensor for Color Cameras. Image-sensing devices can contain millions of sampling sites, each having a photosensitive device or ‘sensor’ and the photosensors being divided into a plurality of color channels. Each sensor records the intensity of the light that falls on it by converting photons into an electrical charge and accumulating the electrical charge over a fixed period of time. For each sensor, the collected charges are then processed into a signal which is subsequently digitized and the digital products saved in one of the many known digital image formats from which the image may be displayed, printed or further processed.

The photosensor's sensitivity to light varies as a function of wavelength. This sensitivity is usually adjusted to correspond to a particular color of light by means of a filter which selectively attenuates the light as a function of frequency.

One commonly used system utilizes filters representative of three additive primary colors of red, green, and blue (RGB), however other color systems are also known, including for example a system which utilizes filters of cyan, magenta, yellow and green. The selection of the colors comprising a set of primary colors is to some extent arbitrary and in theory many colors could be used. In a system whereby the colors are too broad, for example, cyan, magenta and yellow, the final computed RGB values generally suffer from an excess of noise. Conversely, if the colors are too narrow, the camera will have gaps in its sensitivity. For example, if red and green are very narrow, a yellow colored object which falls right between the passbands of the two filters may not be visible to the camera at all.

Typical wavelength values of primary colors in an RGB system are 640 nm (red), 537 nm (green), and 464 nm (blue).

A well known technique used in many digital cameras for recording color images involves placing one color filter over each individual photosensor so that each photosensor can capture only one of the primary colors of the particular color system in use. For instance for an RGB system, repeating patterns of photosensors may be arranged such that each one of these photosensors has either a green, red, or blue filter placed to filter the light falling onto it.

Some manufacturers of digital cameras have used even more than three different filter colors. For instance, Hewlett Packard has previously developed a camera that used four color channels with filters of cyan, magenta, yellow and green. Whilst it is common practice to convert from one set of colors to another (eg. from the sensor color system to a target color system) using a linear transformation, the conversion has the disadvantage of amplifying the signal noise. Furthermore, the amplification of noise increases when the difference between the target set of colors and the sensor set of colors increases.

The majority of manufactures of digital cameras therefore use image sensor devices employing a three-color system in which each filter/photosensor combination has a profile that approximates the corresponding desired output target color. However this solution is problematic in that the target colors each have a narrow spectral bandwidth and as a result, the sensors do not record very much light. In some imaging applications a greater output is achieved by adopting filters associated with the photosensors which have spectral bandwidths that are more broadly tuned than would be ideal for optimal color rendition. Whilst this approach has the advantage of improving color sensitivity it also has the drawback of reducing the overall color quality. Furthermore, heightened sensitivity is only useful in shadow regions and generally causes saturation in highlighted areas of the resultant image.

Another type of image sensing device which is sometimes seen in more expensive imaging systems employs a beam splitter to split the light delivered from a lens system into several paths each of which include a color filter and an image photosensor array. This approach avoids having to create a mosaic of filters in front of the photosensors, but introduces losses associated with the beam splitter, is bulkier and requires one photosensor array for each of the beams emerging from the beam splitter.

Prior art systems, where each color channel of an image sensing device contains sensors sensitive to a single spectral bandwidth, therefore suffer from either low saturation levels causing loss of detail in highlight areas and/or restricted sensitivity causing loss of detail in shadow areas and possibly further loss of detail where image colors fall between the spectral bandwidths of the respective color channels.

### SUMMARY OF THE PRESENT INVENTION

Accordingly an image sensing device is provided comprising a plurality of photosensors arranged in at least one array, such that each of the photosensors converts incident light into an output signal, the photosensors and their respective output signals being divided into a plurality of color channels. A filter is associated with each of the photosensors, the filters selecting light within predetermined spectral bands for conversion by the photosensors into the output signals. One of the color channels is divided into at least two sub-channels and the filters associated with the photosensors of the at least two color sub-channels have overlapping spectral bands wherein one of the overlapping spectral bands is narrower in bandwidth than another of the overlapping spectral bands.

An image sensing device and a method of capturing an image will now be described by way of example, with reference to the accompanying drawings.

### BRIEF DESCRIPTION OF THE DRAWINGS

FIG. 1 is a schematic illustration of an image-sensing device with one portion shown in detail and in which a matrix of photosensors are provided arranged into four color channels or sub-channels;

FIG. 2 is a schematic illustration of a portion of the image-processing region of a digital image capture device into which the image sensing device of FIG. 1 is incorporated;

FIG. 3 is a schematic illustration of an alternative image-sensing device in which four arrays of photosensors are provided, each array associated with a respective color channel or sub-channel and light is distributed to each of the arrays by way of a beam splitter;

FIG. 4 is a schematic illustration of a further alternative image-sensing device in which three arrays of photosensors are provided and light is distributed to each of the arrays by way of a beam splitter whereby two of the arrays are associated with a respective color channel and the third array is associated with two color sub-channels.

FIG. 5 graphically illustrates a response function from a first and second color sensor of a single color channel (such as the green color channel of the embodiment of FIG. 1) in an image sensing device; and

FIG. 6 is a flow chart of a method of capturing an image.

### DETAILED DESCRIPTION OF EMBODIMENTS OF THE PRESENT INVENTION

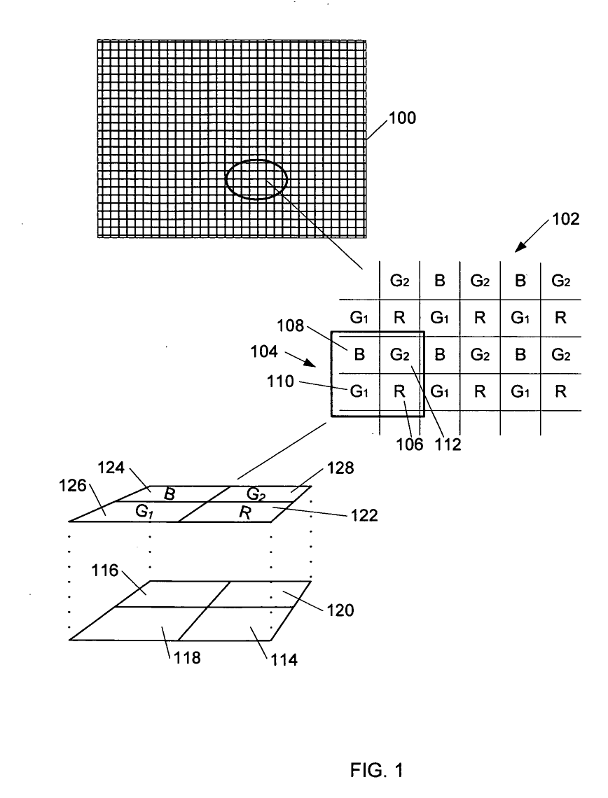

FIG. 1 schematically illustrates a portion of an image-sensing device 100 showing in detail a subset 102 of the photosensors of the device and in particular a grouping 104 of four photosensors 106, 108, 110, 112 of the device. Each grouping 104 has a first color channel comprising a ‘red color photosensor’ 106, a second color channel comprising a ‘blue color photosensor’ 108, and a third color channel comprising a first green color sub-channel having a first ‘green color photosensor’ 110 and a second green color sub-channel having a second ‘green color photosensor’ 112. Each of the four color photosensors, 106, 108, 110 & 112 comprises a photodiode 114, 116, 118 & 120 and filter 122, 124, 126 & 128 in combination to filter out all but the wanted wavelengths of the incident light and to convert the wanted wavelengths into output signals of the respective color channel or sub-channel. In the case of the green color channel, the first green filter/photosensor combination 110 has a filter 126 which is tuned to accept a broader band of wavelengths than the second green filter/photosensor combination 112 and therefore the first filter/photosensor combination has a higher sensitivity and is able to register lower levels of light than the second filter/photosensor combination. In contrast the second green filter/photosensor combination 112, because it is tuned to a narrower band of wavelengths than the first green filter/photosensor combination 110, has a lower sensitivity than the first filter/photosensor combination 126, 110, and is therefore less easily saturated.

Image-sensing devices may, be integrated using architectures such as CCD, CID or CMOS architecture. The image-sensing device 100 may for example employ a sensor chip such as a Sony™ ICX205AL Progressive Scan CCD Image Sensor for B/W Cameras, to which a mosaic of primary color filters has been fitted. Alternatively the design of a device such as a Sony™m ICX205AK Progressive Scan CCD Image Sensor for Color Cameras may be modified to replace half of the green filters in the in-built mosaic of filters with filters having a narrower acceptance bandwidth.

The image sensing device may be incorporated in an image capture apparatus such as an analog or digital video camera, a digital still camera, a scanner such as film or flat bed scanner, or other imaging systems and devices.

The filters 122, 124, 126, 128 may for example comprise:—
1) Kodakt™ Wratten™ #58 (green tricolor) for the first green filter 126
2) Kodak™ Wrattent™ #99 (green) for the second green filter 128
3) Kodakt™ Wratten™ #25 (red tricolor) for the red filter 122
4) Kodak™ Wratten™ #47 (blue tricolor) for the blue filters 124

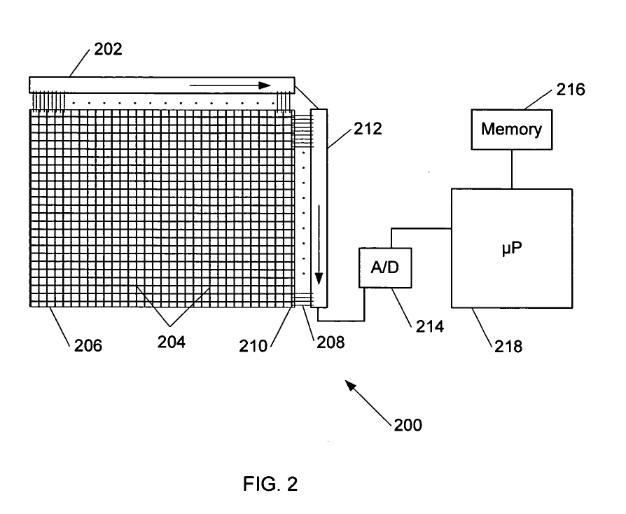

FIG. 2 is a schematic illustration of a portion of the image-processing region of a digital image capture device into which the image-sensing device of FIG. 1 is incorporated. The image-sensing device in this example is a CCD 200. In accordance with CCD architecture a shift control circuit 202 controls the transport of an output signal from each photosensor location 204 to the next across the photosensor array 206. The output signals 208 on the last row 210 of the photosensor array 206 are then transferred to the readout register 212. Once the signals in the last column 210 of photosensor locations 204 has been shifted to the readout register 212, the signals in the readout register are sequentially shifted into an analog to digital (A/D) converter 214 where they are digitized before being stored in digital memory 216 of a microprocessor 218. Once all of the pixels in the readout register 212 have been digitized and stored, the signals in the photosensor array 206 are again shifted by one photosensor location toward the readout register 212 such that the new signals in the last column 210 of photosensor locations 204 after the previous shift operation enter the readout register 212. This process continues until all of the signals in the photosensor array 206 have been read out. The captured and stored image is then available for further processing or for reconstruction for display on a display monitor or for printing.

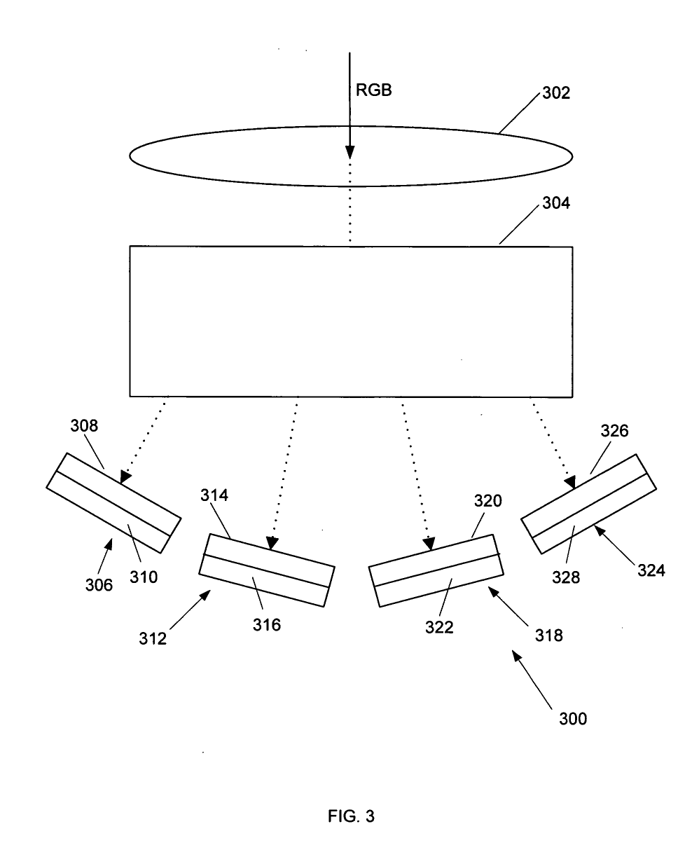

An alternative embodiment of an image sensing device is schematically illustrated in FIG. 3. In this embodiment, only a portion of which is shown, light typically enters the system 300 through a lens system 302 and is passed through a beam splitter 304 (eg. a series of prisms) which splits the light entering the imaging system into three color channels red, blue and green, where the green color channel has first and second sub-channels. Four image sensing devices 306, 312, 318 and 324 are provided, each comprising an array of photosensors, 310, 316, 322 and 328, and a filter 308, 314, 320 and 326 where each filter covers the entire area of the respective photosensor array. Each array of photosensors 310, 316, 322 and 328 may be implemented using a device such as the Sony™ ICX205AL Progressive Scan CCD Image Sensor for B/W Cameras or any similar device that does not include a mosaic of filters.

Photosensors 310 and 316 of sensors 306 and 312 convert light in spectral bands that approximate the primary colors red and blue respectively. Photosensor 318 of image sensor 306 converts light in a first broad spectral band which approximates the primary color green whereas photosensor 328 of image sensor 324 converts light in a second narrower spectral band which also approximates the primary color green in a similar manner to the green sub-channels of the earlier embodiment. The photosensor arrays are then each unloaded in a similar fashion to that of the previous embodiment and the image components are then combined in an image processor (not shown).

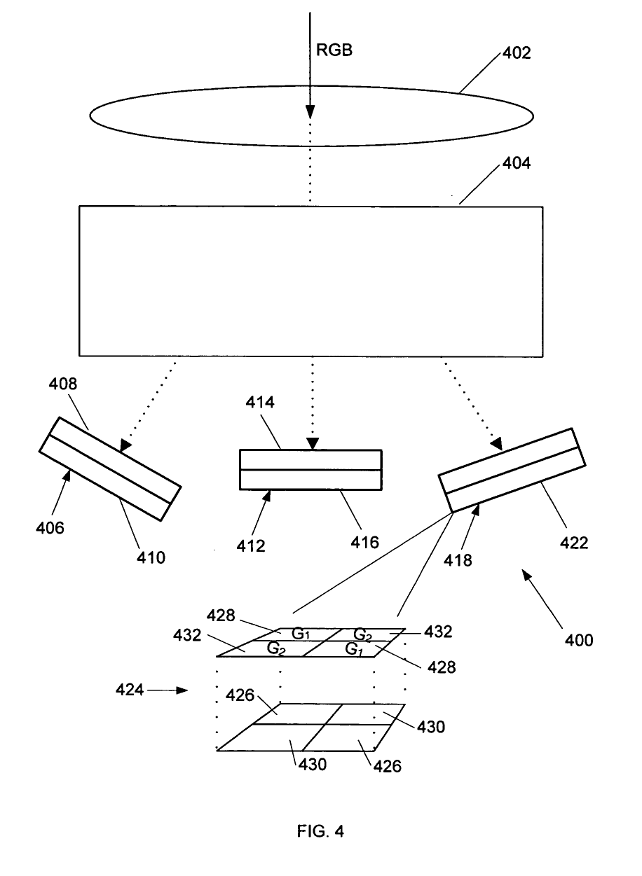

A further alternative embodiment of an image sensing device is schematically illustrated in FIG. 4, in which only a portion of the device is shown.

In this embodiment, similar to the embodiment illustrated in FIG. 3, light enters the system 400 through a lens system 402 and is passed through a beam splitter 404 which splits the light entering the system into three color channels red, blue and green. In this embodiment, three image sensing devices 406, 412, and 418 are provided. Image sensing devices 406 and 412 each comprise an array of photosensors 410 and 416 and respective filters 408 and 414 where each filter covers the entire area of the respective photosensor array. Photosensors 410 and 416 of sensors 406 and 412 convert light in spectral bands that approximate the primary colors red and blue respectively.

Image sensing device 418 on the other hand comprises an array of photosensors 422 of which only a grouping of four photosensors 424 is shown in detail. Each grouping has a pair of first green color sensors diagonally spaced from one another, each having a photodiode 426 and a filter 428 and a pair of second green color sensors each having a photodiode 430 and a filter 432. The filter 428 of the first green filter/photosensor combination is tuned to accept a broader rang of wavelengths than the second green filter/photosensor combination.

The image-sensing device may comprise three or more color channels. In an alternative arrangement to those described above four color channels are provided where each of the channels is indicative of the one of the colors cyan, magenta, yellow and green respectively.

In a variation of the three color arrangements described above, the green color channel may comprise three or more sub-channels such that a filter of the first sub-channel is broadly tuned in spectrum, a filter of the second sub-channel is narrowly tuned in spectrum, and the filters of the remaining sub-channel(s) are tuned to bands between those of the first and second sensors.

In particular applications it may for example be advantageous to provide two or more sensors for the red channel or the blue channel rather than the green channel.

Narrow band filters that may possible be used in a red sub-channel include Kodak™ Wratten™ 29 or 92 and narrow band filters that may possible be used in a blue sub-channel include Kodakt™ Wratten™ 47B or 98.

In a still further example, more than one of the color channels and possibly all of the color channels may each comprise a plurality of sub-channels such that a filter of the first sub-channel for each respective color channel is broadly tuned in spectrum, the filter of the second sub-channel for each respective color channel is narrowly tuned in spectrum and the filters of any remaining sub-channels are tuned to bands between those of the first and second sub-channels of the respective color channel.

It should be appreciated that the invention is not limited to any particular combination of sensors and color channels and that the examples provided above are provided for illustrative purposes only.

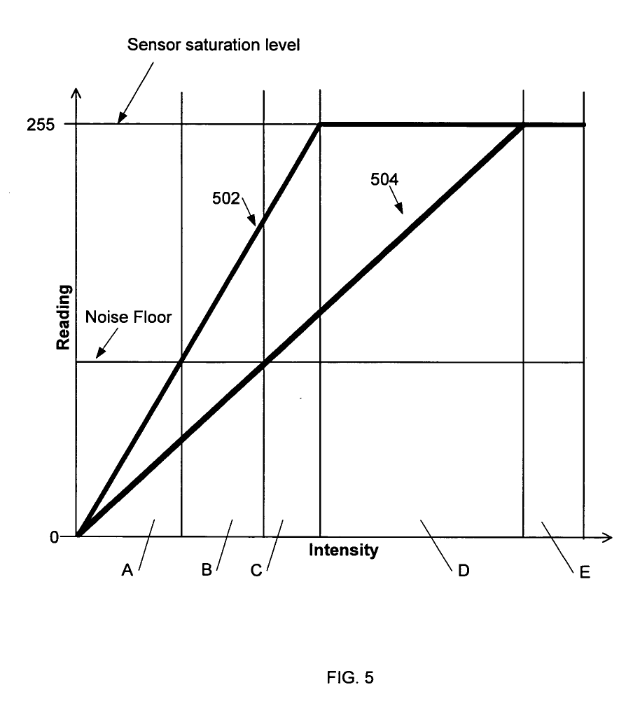

The graph illustrated in FIG. 5 shows output characteristics for two photosensors 502, 504 having filters with different spectral bandwidths (eg. Kodakt™ Wratten™ #58 (green tricolor) and Kodakt™ Wrattent™ #99 (green)) associated with two sub-channels of a single color channel of a photosensor array. The filter of the first photosensor 502, is tuned to a broad spectral bandwidth, whilst the filter of the second photosensor 504, is tuned to a narrow spectral bandwidth.

For low levels, or intensities of incident light on each photosensor 502, 504, the output of the sensor will not rise above an inherent noise floor and any useful signal is accordingly masked. Incident light levels falling at or below the noise floor are accordingly treated as black levels. On the other hand when high incident light levels fall on a sensor, the sensor is caused to saturate. Levels between these two extremes can be recorded by the photosensor as varying shades or tones between the black and saturation levels.

Referring again to the graph of FIG. 5, the combined effect of the two photosensors 502 and 504 is to provide five different output areas depending on the intensity of the incident light that registers on each of the sensors. Area A represents darkness, where the signal generated by each of the sensors is unregistrable over the noise level. Area B represents areas of shadow detail, or regions of relatively low light intensity where only the photosensor 502 with a broad spectral-band filter registers a signal raising above the noise floor. In Area B, the photosensor 502 is able to register light because broad spectral bandwidth of the filter associated with the photosensor rejects fewer photons than that of the narrow-band photosensor 504. In contrast, the signal generated by the narrow spectral-band photosensor 504 still remains unregistrable over the noise level because the narrower spectral-bandwidth of the filter associated with the photosensor rejects a larger proportion of the incident photons. Area C represents mid-tones, where the intensity of light incident on each of the photosensors 502 and 504 is sufficient for them to generate a signal that is above the noise floor. The fourth Area, D represents areas of highlight detail, or regions of relatively high light intensity where only the photosensor 504 with a narrow spectral-band filter registers a signal below the saturation level. In Area D, the photosensor 504 is able to register a non-saturated signal because the narrow spectral-bandwidth of the filter associated with the photosensor rejects a larger proportion of incident photons than the broad-band photosensor 502 and is therefore less easily driven into saturation. In contrast, at this intensity of incident light, the broad spectral-band filter of photosensor 502 is passing more photons than are required to drive the output of the photosensor into saturation. Finally, area E represents full highlight, where both of the photosensors have been driven into saturation. By suitably scaling and combining the output signals of the two photosensors 502 and 504 it is possible to generate a range of recorded light intensities within a given color channel which greatly exceed those that can be captured with a single photosensor. Employing more than two photosensors per color channel can further extend the range.

In comparison with prior art systems where each color channel of an image sensing device contains sensors sensitive to a single spectral band, this image sensing device has the advantage of improved dynamic range or exposure latitude and offers the possibility of improved sensitivity providing greater detail in shadow areas and/or higher saturation levels giving improved detail in highlight areas. As illustrated in FIG. 5, the combination of dual sensors for a single color provide a useful output over a greater range of input intensities than will be the case for a single sensor.

A method of capturing an electronic representation of an image will now be described. In a first step of the method, the image is projected onto a sensor device comprising a plurality of photosensors. The wavelengths of light incident on each photosensor are restricted to a spectral band defining a color associated with the color channel of the respective photosensor. The output of each photosensor is therefore a measurement of the intensity of light incident on the respective photosensor. The outputs of the photosensors are then combined to generate an electronic representation of the image. One color channel is divided into at least two sub-channels having overlapping spectral bands wherein one of the overlapping spectral bands is narrower in bandwidth than another of the overlapping spectral bands.

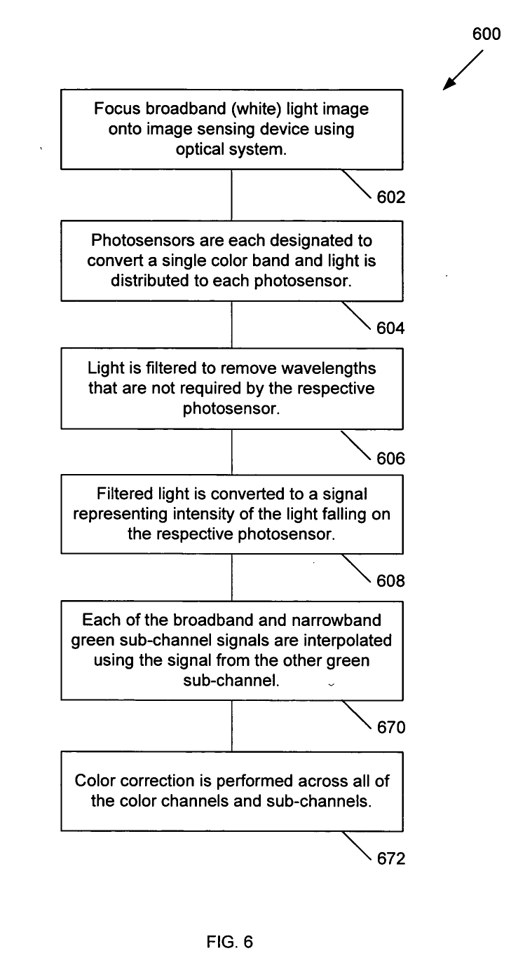

Referring to FIG. 6 a flow chart 600 is illustrated showing the steps of the image capturing method. The first step 502 in any imaging process is to project the image onto the sensor device. This is typically performed by using a lens system to focus light from a scene (or in the case of a scanning system from a document or item to be scanned) onto the image sensor device. Depending upon the type of imaging system in use, the projected image is distributed 604 to sensors associated with different color channels, either by mixing the individual photosensors in a single photosensor array, or by splitting the projected image into a number of beams (using a beam splitter) and using a separate array to detect each color channel. In either case a filter is used in the light path to each photosensor to restrict 606 the wavelengths of light incident on each photosensor to only those wavelengths associated with the color channel of the photosensor. In the case of the light splitter approach a single filter element may be employed over each photosensor array, whereas in the case where photosensors of a given color channel are spatially distributed with those of other channels in a single array, a mosaic of filters will be employed over the array. However in each case at least one color channel is divided into sub-channels including at least one sub-channel tuned to record a broad band of wavelengths and one tuned to record a narrow band of wavelengths. In the example given above the green channel is divided into two sub-channels using respectively a Kodakt™ Wratten™ #58 (green tricolor) filter to select a broad band of green wavelengths and a Kodak™ Wratten™ #99 (green) to select a narrow band of green wavelengths. On the other hand the Red and Blue channels may use respectively a Kodak™ Wratten™ #25 (red tricolor) to select a broad band of red wavelengths and a Kodak™ Wratten™ #47 (blue tricolor) to select a broad band of blue wavelengths.

The intensity of light falling on each photosensor is measured using one or more sensor arrays of a type such as the Sony ICX205AL and digitized using a suitable analog to digital converter. For the green channel, and/or any other channel that has multiple sub-channels, the sub-channel signals are scaled and extended 610 by interpolation of signals from the other sub-channels of the same color channel. Therefore, in the case of those areas of input intensity where one of the sub-channel sensors is producing an output that is either at the black level or the saturation level, the suitably scaled outputs of other photosensors of the same color channel are used to interpolate a signal for the photosensor that has an output at the black level or the saturation level.

Finally the color channel and sub channel signals are color corrected 612 using, for example, 4×3 color correction matrix, to produce a digital image with three channels of color such as an Srgb image. The color correction step is also known as demosaicing, and is used to convert the raw image data from the photosensor array into a resultant standard image format; that is, calculating the red, green, and blue intensities of nominal pixel locations of the resultant image from the photosensor array data. Since respective color channels of the photosensor array may not be aligned to a rectangular sampling geometry, an algorithm such as that proposed by David Taubman may be utilized (Taubman, David. Generalized wiener reconstruction of images from color sensor data using a scale invariant prior, Proceedings of the 2000 International Conference on Image Processing (ICIP 2000), 10-13 Sep. 2000). A variation of this algorithm may be employed to allow for the multiple sub-channels within a single color channel.

Thus various embodiments and components have been shown for creating an image sensing system, and these may be used singly or in combination, or with other elements known in the arts of optical design, and color science. It is understood that these and other such combinations, substitutions, and alternative embodiments may be undertaken according to the requirements and materials at hand without deviating from the spirit of the invention, the scope of which is to be limited only by the claims appended hereto.

1. An image sensing device comprising:
a plurality of photosensors arranged in at least one array, such that each of the photosensors converts incident light into an output signal, the photosensors and their respective output signals being divided into a plurality of color channels;
a filter associated with each of the photosensors, the filters selecting light within predetermined spectral bands for conversion by the photosensors into the output signals, one color channel comprising at least two color sub-channels and the filters associated with the photosensors of at least two of the color sub-channels having overlapping spectral bands wherein one of the overlapping spectral bands is narrower in bandwidth than another of the overlapping spectral bands

2. The image sensing device of claim 1 wherein the photosensors are arranged in a single array and the filters associated with each photosensor are arranged in a mosaic of filters located over the photosensor array.

3. The image sensing device of claim 2 wherein the mosaic of filters is arranged in a Bayer pattern.

4. The image-sensing device of claim 1 wherein a beam splitter is provided which splits incident light into a plurality of paths and a separate filter/photosensor array combination is located in each path, there being a separate path and respective filter/photosensor array combination provided for each color channel or sub-channel.

5. The image-sensing device of claim 1 wherein a beam splitter is provided which splits incident light into a plurality of paths and a separate filter/photosensor array combination is located in each path, there being a separate path and respective filter/photsensor array combination provided for each color channel, and whereby the at least one of the color channels that is further divided into a plurality of sub-channels is represented by a single filter/photosensor array combination wherein a filter associated with each photosensor of the plurality of sub-channels is arranged in a mosaic of filters located over the photosensor array.

6. The image sensing device of claim 1 wherein the color channels comprise red, green and blue color channels and the green color channel is divided into a plurality of sub-channels, a first one of which uses a first green filter type and a second of which uses a second green filter type having a spectral band which is narrower in bandwidth than and overlapping with the spectral band of first green filter type.

7. The image sensing device of claim 6 wherein the first green sub-channel uses a Kodak™ Wratten™ #58 (green tricolor) filter.

8. The image sensing device of claim 7 wherein the second green sub-channel uses a Kodak™ Wratten™ #99 (green) filter.

9. The image sensing device of claim 6 wherein the red channel is divided into a plurality of sub-channels, a first one of which uses a first red filter type and a second of which uses a second red filter type having a spectral band which is narrower in bandwidth than and overlapping with the spectral band of the first red filter type.

10. The image sensing device of claim 6 wherein the blue channel is divided into a plurality of sub-channels, a first one of which uses a first blue filter type and a second of which uses a second blue filter type having a spectral band which is narrower in bandwidth than and overlapping with the spectral band of the first blue filter type.

11. The image sensing device of claim 1 wherein the color channels comprise cyan, yellow, magenta and green color channels and the green channel is divided into a plurality of sub-channels, a first one of which uses a first green filter type and a second of which uses a second green filter type having a spectral band which is narrower in bandwidth than and overlapping with the spectral band of first green filter type.

12. A method of capturing an electronic representation of an image comprising the steps of:
a) projecting the image onto a sensor device comprising a plurality of photosensors, divided into a plurality of color channels;
b) restricting the wavelengths of light incident on each photosensor to a spectral band defining a color associated with the color channel of the respective photosensor;
c) combining the outputs of the photosensors to generate the electronic representation of the image,
wherein one color channel is divided into at least two color sub-channels having overlapping spectral bands wherein one of the overlapping spectral bands is narrower in bandwidth than another of the overlapping spectral bands.

13. The method of claim 12 wherein individual photosensors of the different color channels are intermixed in a single photosensor array, and the step of restricting the wavelengths of light incident on each photosensor comprises positioning an associated filter over the respective photosensor, whereby light falling on the photosensor passes through the associated filter, the filters being arranged as a mosaic of filter elements with a filter element located over each photosensor in the array.

14. The method of claim 13 wherein the mosaic of filter elements is arranged in a Bayer pattern.

15. The method of claim 14 wherein the mosaic of filter elements comprises red, green and blue elements associated with red green and blue color channels and the green color channel comprises two green sub-channels.

16. The method of claim 15 wherein the Bayer pattern comprises alternating rows of filters a first of which includes red filters and green filters of the first green sub-channel and the second of which includes blue filters and green filters of the second green sub-channel.

17. The method of claim 12 wherein a separate photosensor array is associated with each color channel or sub-channel and the image is projected onto the photosensor arrays via a beam splitter which splits incident light into a plurality of paths corresponding to the number of photosensor arrays and each photosensor array having an associated filter which limits the wavelengths of light falling on the respective photosensor array to those of the spectral band of respective color channel or sub-channel.

18. The method of claim 12 wherein a separate photosensor array is associated with each color channel and the image is projected onto the photosensor arrays via a beam splitter which splits incident light into a plurality of paths corresponding to the number of photosensor arrays, each photosensor array having an associated filter or filters which limits the wavelengths of light falling on the respective photosensor array to those of the respective color channel, and wherein at least one of the color channels is further divided into a plurality of sub-channels represented by a single filter/photosensor array combination and a filter associated with each photosensor of the plurality of sub-channels is arranged in a mosaic of filters located over the photosensor array.

19. The method of claim 12 wherein the colors associated with the respective color channels comprise red, green and blue and the green color channel is divided into a plurality of sub-channels, a first one of which uses a green filter type having a first green spectral band and a second of which uses a green filter type having a second green spectral band which is narrower in bandwidth than and overlapping with the first green spectral band.

20. The method of claim 19, wherein the first green sub-channel uses a Kodak™ Wratten™ #58 (green tricolor) filter.

21. The method of claim 20 wherein the second sub-channel uses a Kodak™ Wratten™ #99 (green) filter.

22. The method of claim 19 wherein the red color channel is divided into a plurality of sub-channels, a first one of which uses a red filter type having a first red spectral band and a second of which uses a red filter type having a second red spectral band which is narrower in bandwidth than and overlapping with the first red spectral band.

23. The method of claim 19 wherein the blue color channel is divided into a plurality of sub-channels, a first one of which uses a blue filter type having a first blue spectral band and a second of which uses a blue filter type having a second blue spectral band which is narrower in bandwidth than and overlapping with the first blue spectral band.

24. The method of claim 12 wherein the colors associated with the respective color channels comprise cyan, yellow, magenta and green and the green color channel is divided into a plurality of sub-channels, a first one of which uses a green filter type having a first green spectral band and a second of which uses a green filter type having a second green spectral band which is narrower in bandwidth than and overlapping with the first green spectral band.
